(19) United States
(12) Patent Application Publication
(10) Pub. No.: US 2026/0319728 A1
(43) Pub. Date: Oct. 15, 2026

(54) INTERCONNECTABLE STEREOSCOPIC IMAGE INTERACTION SYSTEM AND METHOD THEREOF

(71) Applicant: LIGHT MATRIX INC., Taipei City (TW)

(72) Inventor: Wei-Ting CHEN, Taipei City (TW)

(21) Appl. No.: 19/260,432

(22) Filed: Jul. 4, 2025

(30) Foreign Application Priority Data
Apr. 14, 2025 (TW) 114114027

(51) Int. Cl. G06F 3/14; G06K 7/10; G06K 7/14; G06T 13/40; G09G 3/00

(52) U.S. Cl. CPC G06F 3/1454; G06T 13/40; G09G 3/003; G06K 7/10297; G06K 7/1417; G09G 2370/02

(57) ABSTRACT

An interconnectable stereoscopic image interaction system and a method thereof are disclosed. In the system, a sensor of a handheld box-type stereoscopic display device senses an identification component to obtain an object identifier; the handheld box-type stereoscopic display devices are connected to each other through transmission components thereof to exchange the sensed object identifiers; each handheld box-type stereoscopic display device uses the object identifier of another handheld box-type stereoscopic display device as a target identifier, loads a primary image and a secondary image based on the object identifier thereof and the received target identifier to generate virtual stereoscopic images with a primary-secondary relationship for display, thereby achieving the technical effect of enhancing the diversity and interactivity of virtual stereoscopic image.

### CROSS-REFERENCE STATEMENT

The present application is based on, and claims priority from, TAIWAN Patent Application Serial Number 114114027, filed 2025 Apr. 14, the disclosure of which is hereby incorporated by reference herein in its entirety.

### BACKGROUND OF THE INVENTION

### 1. Field of the Invention

The present invention relates to a stereoscopic image interaction system and a method thereof, more particularly to an interconnectable stereoscopic image interaction system and a method thereof.

### 2. Description of the Related Art

In recent years, with the widespread and rapid development of stereoscopic image technology, various corresponding technologies have emerged, for example, stereoscopic display, holographic Imaging, light field display, autostereoscopic display, augmented reality (AR), virtual reality (VR). However, the simple way of displaying images has gradually failed to meet the needs of users.

Generally, to make the displayed image have a stereoscopic visual effect, the basic principle is to use parallax and binocular vision or use optical principles (such as holographic imaging, light field display) to achieve the stereoscopic visual effect. However, in the conventional stereoscopic visual method, the viewer is usually a passive receiver, the viewer cannot interact with other viewer, such as taking photos together, fighting, or communicating, so there is a conventional problem of insufficient diversity and interactivity of virtual stereoscopic image.

Therefore, what is needed is to develop an improved solution to solve the problem of insufficient diversity and interactivity of the virtual stereoscopic image.

### SUMMARY OF THE INVENTION

An objective of the present invention is to disclose an interconnectable stereoscopic image interaction system and a method thereof, to solve the conventional problem.

To achieve the objective, the present invention discloses an interconnectable stereoscopic image interaction system, the system includes handheld box-type stereoscopic display devices, and each handheld box-type stereoscopic display device includes a sensor, a transmission component, a storage unit, a loading unit, and an image interaction unit. The sensor is configured to sense an identification component to obtain an object identifier. The transmission component is configured to perform connection with another handheld box-type stereoscopic display devices; after the connection, the transmission component transmits the sensed object identifier by the sensor and receive the at least one object identifier sensed by another of the handheld box-type stereoscopic display devices and uses the received object identifier as at least one target identifier. The storage unit is configured to store stereoscopic images, wherein each of the stereoscopic images corresponds to an image identifier. The loading unit is connected to the transmission component, the storage unit, and the sensor, and configured to compare the obtained object identifier and the received target identifier with the image identifiers, respectively, wherein when the obtained object identifier matches with one of the image identifiers, the loading unit loads the corresponding stereoscopic image as an primary image, when the received target identifier matches with one of the image identifiers, the loading unit loads the corresponding stereoscopic image as at least one secondary image. The image interaction unit is connected to the loading unit and configured to generate virtual stereoscopic images with a primary-secondary relationship for display based on the primary image and the secondary image.

To achieve the objective, the present invention discloses an interconnectable stereoscopic image interaction system, the system includes sensible objects and handheld box-type stereoscopic display devices. Each of the sensible objects has an identification component to be sensed. Each of the handheld box-type stereoscopic display devices includes a sensor and a smart device. The sensor is configured to sense the identification component of one of the sensible objects to obtain an object identifier. The smart device includes a network unit, a storage unit, a loading unit and an image interaction unit. The network unit is connected to network for transmitting data through a wireless transmission component, and configured to perform a connection with another of the handheld box-type stereoscopic display devices, wherein after the connection, the network unit transmits the sensed object identifier sensed by the sensor, receives the object identifier sensed by the another of the handheld box-type stereoscopic display devices, and uses the received object identifier as a target identifier. The storage unit is connected to the network unit and configured to store stereoscopic images, wherein each of the stereoscopic images corresponds to an image identifier and is updated through the network unit. The loading unit is connected to the network unit, the storage unit and the sensor, and configured to compare the obtained object identifier and the received target identifier with the image identifiers, respectively, wherein when one of the image identifiers matches with the object identifier, the loading unit loads the corresponding stereoscopic image as an primary image, and when one of the image identifiers matches with the target identifier, the loading unit loads the corresponding stereoscopic image as a secondary image. The image interaction unit is connected to the loading unit and configured to generate virtual stereoscopic images with a primary-secondary relationship for display based on the primary image and the secondary image.

To achieve the objective, the present invention discloses an interconnectable stereoscopic image interaction method executed in handheld box-type stereoscopic display devices, includes steps of: sensing an identification component to obtain an object identifier through a sensor, and storing stereoscopic images, by each of the handheld box-type stereoscopic display devices, wherein each of the stereoscopic images corresponds to an image identifier; connecting to another of the handheld box-type stereoscopic display devices through a transmission component, and after connection, transmitting the sensed object identifier, receiving the object identifier sensed by the another of the handheld box-type stereoscopic display devices and using the received object identifier as a target identifier, by each of the handheld box-type stereoscopic display devices; comparing the obtained object identifier and the received target identifier with the image identifiers, respectively, when the obtained object identifier matches with one of the image identifiers, loading the corresponding stereoscopic image as a primary image, and when the received target identifier matches with one of the image identifiers, loading the corresponding stereoscopic image as an at least one secondary image, by each of the handheld box-type stereoscopic display devices; generating virtual stereoscopic images with a primary-secondary relationship for display based on the primary image and the secondary image, by each of the handheld box-type stereoscopic display devices.

To achieve the objective, the present invention also discloses an interconnectable stereoscopic image interaction method applied in an environment with sensible objects and handheld box-type stereoscopic display devices, the method includes steps of: connecting each of the handheld box-type stereoscopic display devices to network through a wireless transmission component to download stereoscopic images for storage and updating, wherein each of the stereoscopic images corresponds to an image identifier; performing connection with another of the handheld box-type stereoscopic display devices through a wireless transmission component, and sensing an identification component of the sensible object through a sensor thereof to obtain an object identifier, and after the connection, transmitting the sensed object identifier, receiving the object identifier sensed by the another of the handheld box-type stereoscopic display devices and using the received object identifier as a target identifier, by each of the handheld box-type stereoscopic display devices; comparing the obtained object identifier and the received target identifier with the image identifiers, respectively, and when the obtained object identifier matches one of the image identifiers, loading the corresponding stereoscopic image as a primary image, and when the target identifier matches one of the image identifiers, loading the corresponding stereoscopic image as a secondary image, by each of the handheld box-type stereoscopic display devices; generating virtual stereoscopic images with a primary-secondary relationship for display based on the primary image and the secondary image, by each of the handheld box-type stereoscopic display devices.

According to the system and method disclosed in the present invention are as described above, the difference between the conventional technology and the present invention is that, in the present invention, the sensor of each handheld box-type stereoscopic display device senses the identification component to obtain the object identifier; the handheld box-type stereoscopic display devices are connected to each other through the transmission components thereof to exchange the sensed object identifiers; each handheld box-type stereoscopic display device uses the object identifier of another handheld box-type stereoscopic display device as the target identifier, loads the primary image and the secondary image based on the object identifier thereof and the received target identifier to generate virtual stereoscopic images with the primary-secondary relationship for display.

According to the above-mentioned solution, the present invention can achieve the technical effect of enhancing the diversity and interactivity of the virtual stereoscopic image.

### BRIEF DESCRIPTION OF THE DRAWINGS

The structure, operating principle and effects of the present invention will be described in detail by way of various embodiments which are illustrated in the accompanying drawings.

FIG. 1 is a block diagram of an interconnectable stereoscopic image interaction system, according to the present invention.

FIG. 2 is another block diagram of an interconnectable stereoscopic image interaction system, according to the present invention.

FIG. 3 is a flowchart of an interconnectable stereoscopic image interaction method, according to the present invention.

FIG. 4 is another flowchart of an interconnectable stereoscopic image interaction method, according to the present invention.

FIG. 5 is a schematic view of an operation of connecting handheld box-type stereoscopic display device, according to an application of the present invention.

FIG. 6 is a perspective exploded view of a handheld box-type stereoscopic display device, according to the present invention.

FIG. 7 is a schematic view of a hardware architecture of a smart device, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a,” “an” and “the” are intended to include the plural forms as well, unless the context clearly indicates otherwise.

It is to be acknowledged that, although the terms “first,” “second,” “third,” and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

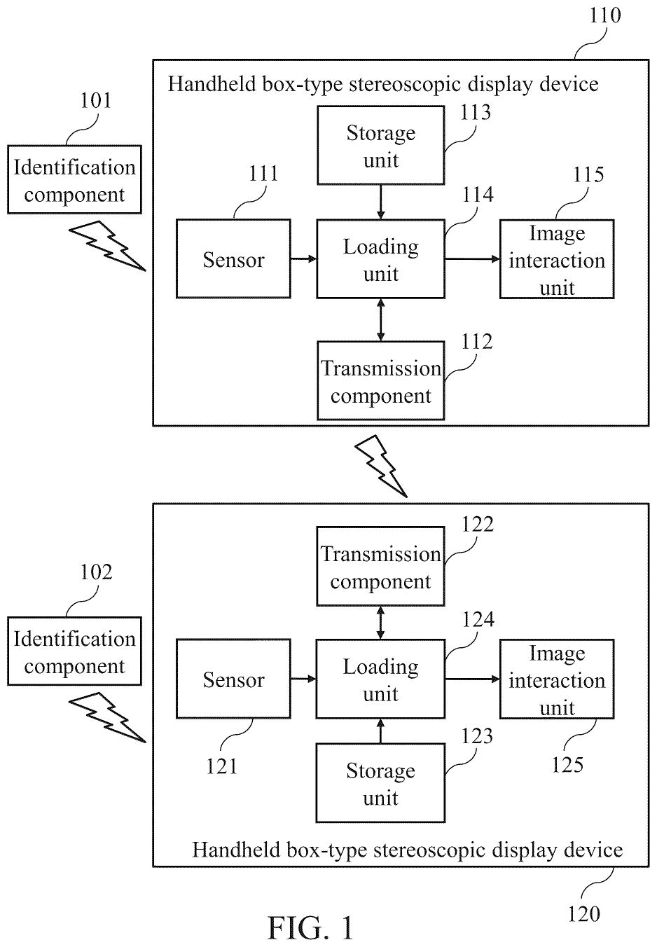

Please refer to FIG. 1. FIG. 1 is a block diagram of an interconnectable stereoscopic image interaction system, according to the present invention. The system includes handheld box-type stereoscopic display devices 110 and 120, the handheld box-type stereoscopic display device 110 includes a sensor 111, a transmission component 112, a storage unit 113, a loading unit 114, and an image interaction unit 115; another handheld box-type stereoscopic display device 120 also includes a sensor 121, a transmission component 122, a storage unit 123, a loading unit 124, and an image interaction unit 125. The sensors 111 and 121 are used to sense the identification components 101 and 102 to obtain the object identifiers, respectively. In actual implementation, each of the sensors 111 and 121 can include a wireless sensor or an optical sensor, each of the identification components 101 and 102 can include a smart tag (such as an RFID tag) or a QR code; the wireless sensor is used to sense the smart tags to obtain the object identifier; the optical sensor (such as infrared scanner) is used to scan the QR code to obtain the object identifier. In addition, the object identifier comprises data representing a plurality of object categories, these object categories include main bodies, clothes, accessories, weapons, and armors. In actual implementation, different characters can be used to represent different object categories, for example, “A” can be used to represent the category of main body, “B” is used to represent the category of clothes, “C” is used to represent the category of accessory, and so on; different numbers can be added after the characters to represent different identification components in the same object category, for example, the object identifiers A001 and A002 represent different identification components in the same object category (i.e., main body), respectively. When the sensor 111 (121) senses more than one identification component (such as RFID tags) to obtain corresponding object identifiers, the loading unit 114 (124) can load the corresponding stereoscopic images, the image interaction unit 115 (125) executes the avatar system to perform an image integration on the loaded stereoscopic images into the primary image; when target identifiers are received, the secondary image is generated in the same loading and integration manner. The avatar system selects at least one of model stitching, multi-view reconstruction, 3D rendering and composition, and 3D hierarchical composition to perform the image integration. In addition, each of the stereoscopic images corresponds to a prompt. When the loading units 114 (124) loads the stereoscopic image, the loading units 114 (124) simultaneously loads the corresponding prompt, so that the avatar system can generate the virtual stereoscopic image through a generative AI model of text to video based on the loaded prompt. It is particularly noted that the generative AI model can be pre-trained with stereoscopic images and corresponding prompts to generate the corresponding image based on the text.

The transmission component 112 (122) are configured to perform a connection to another handheld box-type stereoscopic display device 120 (110); after the connections, the transmission component 112 (122) transmit the sensed object identifier, receive the object identifiers sensed by the another handheld box-type stereoscopic display device 120 (110), and use the received object identifiers as a target identifier. In actual implementation, the transmission component 112 (122) can connect to the another handheld box-type stereoscopic display device 120 (110) through a wired or wireless manner. For example, in wired transmission, the transmission component has transmission pins including a transmission pin (Tx) and a receiving pin (Rx), in this way, the handheld box-type stereoscopic display device 110 can transmit the sensed object identifier to the handheld box-type stereoscopic display device 120 through the transmission pin, and the handheld box-type stereoscopic display device 120 can use the received object identifier as the target identifier. Similarly, the handheld box-type stereoscopic display device 120 can transmit the sensed object identifier to the handheld box-type stereoscopic display device 110 through the transmission pin, and the handheld box-type stereoscopic display device 110 can use the received object identifier as the target identifier. For example, in wireless transmission, the transmission component 112 and 122 connects to each other through Bluetooth, Wi-Fi, or similar wireless communication technology, so that each of the handheld box-type stereoscopic display devices 110 and 120 can transmit the sensed object identifier through wireless means and use the object identifier of another handheld box-type stereoscopic display device as the target identifier.

Each of the storage units 113 and 123 is configured to store stereoscopic images. Each of the stereoscopic images corresponds to an image identifier. In actual implementation, the storage unit 113 and 123 can be implemented by disk, optical disk, non-volatile memory, relational database, or non-relational database (NoSQL).

The loading unit 114 (124) is connected to the transmission component 112 (122), the storage unit 113 (123), and the sensor 111 (121), configured to compare the obtained object identifier and the received target identifier with the image identifiers, respectively; when one of the image identifiers matches the object identifier, loading unit 114 (124) loads the corresponding stereoscopic image as an primary image, when one of the image identifiers matches the target identifier, loading unit 114 (124) loads the corresponding stereoscopic image as an secondary image. For example, when the object identifier is A001, the loading unit 114 (124) loads the stereoscopic image with the image identifier being A001 as the primary image; when the target identifier is A005, the loading unit 114 (124) loads the stereoscopic image with the image identifier being A005 as the secondary image. It should be noted that, when the object identifiers or the target identifiers are obtained at the same time, the loading unit 114 (124) can load the corresponding stereoscopic images, for example, when the obtained object identifiers are A001 and A002, the loading unit 114 (124) can simultaneously load the stereoscopic image with the image identifier being A001 and the stereoscopic image with the image identifier being A002 as the primary images; similarly, when the obtained target identifiers are A005 and A006, the loading unit 114 (124) can simultaneously load the stereoscopic image with the image identifier being A005 and the stereoscopic image with the image identifier being A006 as the secondary images.

The image interaction unit 115 (125) is connected to the loading unit 114 (124), configured to generate virtual stereoscopic images with a primary-secondary relationship for display based on the primary image and the secondary image. In an embodiment, the primary image and the secondary image are displayed in different layers to distinguish the primary-secondary relationship, for example, when the first layer overlaps the second layer, the primary image is displayed on the first layer and the secondary image is displayed on the second layer, areas of these layers without displayed images are presented in a transparent manner in, so visually the displayed primary image and the secondary image will be regarded as the same image. The structures of the handheld box-type stereoscopic display devices 130 and 140 and the method of generating the virtual stereoscopic images will be described in detail later with the accompanying drawings.

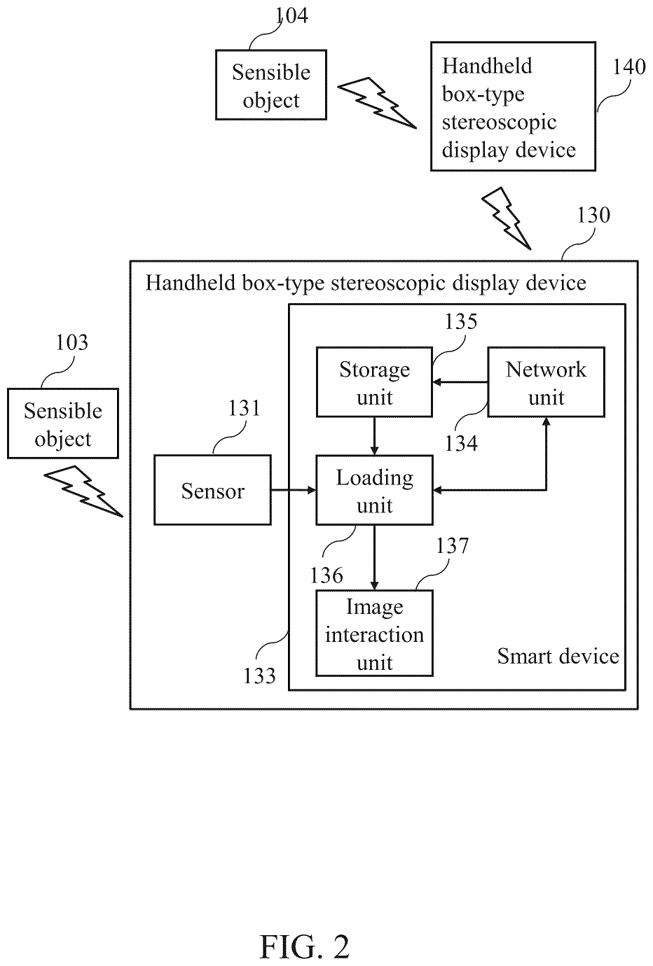

Please refer to FIG. 2. FIG. 2 is another block diagram of an interconnectable stereoscopic image interaction system, according to the present invention. The system includes sensible objects 103 and 104, and handheld box-type stereoscopic display devices 130 and 140. Each of the sensible objects 103 and 104 has a corresponding identification component to be sensed by the handheld box-type stereoscopic display devices 130 and 140. In addition, since the system architectures of the handheld box-type stereoscopic display devices 130 and 140 are the same, only the handheld box-type stereoscopic display device 130 is described below for convenience of explanation.

The handheld box-type stereoscopic display device 130 includes the sensor 131 and the smart device 133, and the sensor 131 is configured to sense the identification component of the sensible object 103 to obtain the object identifier. In actual implementation, the sensor 131 can include an optical sensor, a magnetic sensor (such as near-field magnetic induction), or another sensor capable of sensing the identification component to obtain the object identifier.

The smart device 133 includes the network unit 134, the storage unit 135, the loading unit 136, and the image interaction unit 137. The network unit 134 is connected to the network for transmitting data through a wireless transmission component, thereby performing a connection to another handheld box-type stereoscopic display device 140. After connection, the network unit 134 transmits the sensed object identifier, receives the object identifier sensed by the handheld box-type stereoscopic display device 140, and uses the received object identifier as the target identifier. In actual implementation, the network unit 134 uses wireless transmission technologies such as Wi-Fi, Zigbee, LoRa (Long Range), or similar technologies.

The storage unit 135 is connected to the network unit 134 and configured to store stereoscopic images. Each of the stereoscopic images corresponds to an image identifier and can be updated through the network unit 134. In actual implementation, the storage unit 135 can be implemented by disk, optical disk, non-volatile memory, relational database, or non-relational database (NoSQL).

The loading unit 136 is connected to the network unit 134, the storage unit 135, and the sensor 131, configured to compare the obtained object identifier and the received target identifier with the image identifiers, respectively, when one of the image identifiers matches the object identifier, loading unit 136 loads the corresponding stereoscopic image as an primary image, when one of the image identifiers matches the target identifier, loading unit 136 loads the corresponding stereoscopic image as an secondary image. In actual implementation, the comparison and loading methods of the loading unit 136 are the same as those of the loading unit 114 and 124, so their detailed descriptions are not repeated herein.

The image interaction unit 137 is connected to the loading unit 136, configured to generate virtual stereoscopic images with a primary-secondary relationship for display based on the primary image and the secondary image. In actual implementation, the handheld box-type stereoscopic display device 130 and 140 can be holographic projection devices, the structure of this device and the method of generating the virtual stereoscopic image will be explained in detail later with the diagrams.

Simply speaking, compared to the system block diagram in FIG. 1, the handheld box-type stereoscopic display device 130 in the system block diagram in FIG. 2 has the network unit 134 additionally, all units are disposed in the smart device 133, while the sensor 131 is independent of the smart device 133. The sensor 131 is connected to the loading unit 136, so that the obtained object identifier is transmitted to the loading unit 136. The connection methods and functions of the other units (such as the storage unit 135, the loading unit 136, and the image interaction unit 137) are the same as those in the system block diagram in FIG. 1.

It is particularly noted that, in actual implementation, the units of the present invention can be implemented by various manners, including firmware, hardware or any combination thereof, for example, in an embodiment, the module can be implemented by firmware and hardware, or one of firmware and hardware. Furthermore, the present invention can be implemented fully or partly based on hardware, for example, one or more modules of the system can be implemented by a hardware processor such as an integrated circuit chip, a system on chip (SOC), a complex programmable logic device (CPLD), or a field programmable gate array (FPGA). The concept of the present invention can be implemented by a system, a method and/or a computer program. The computer-readable storage medium records computer readable program instructions, and the processor can execute the computer readable program instructions to implement concepts of the present invention. The computer-readable storage medium can be a tangible apparatus for holding and storing the instructions executable of an instruction executing apparatus. Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc, or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub, and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer or fully executed in a remote computer or a server.

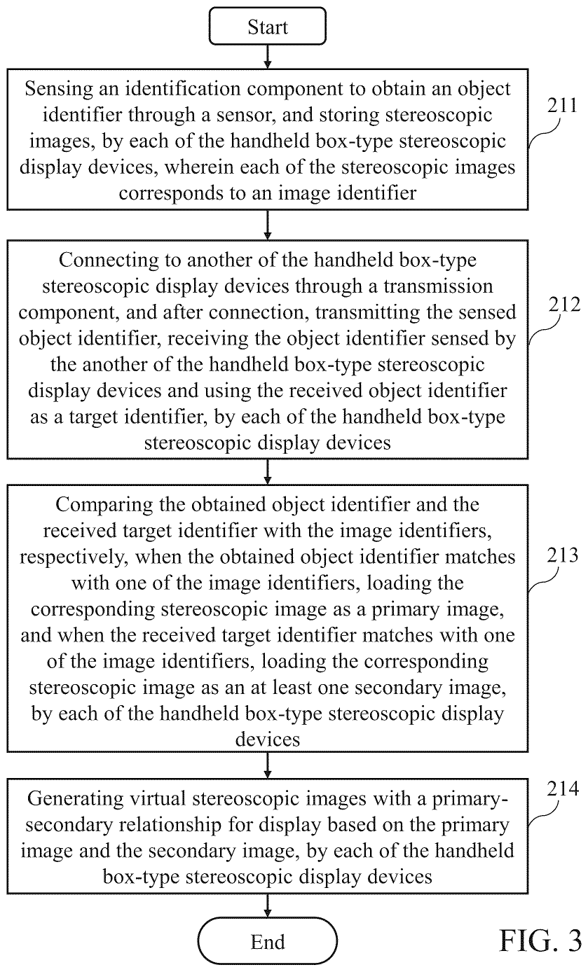

Please refer to FIG. 3. FIG. 3 is a flowchart of an interconnectable stereoscopic image interaction method, according to the present invention. The interconnectable stereoscopic image interaction method can be executed in handheld box-type stereoscopic display device and include the following steps. In a step 211, each of the handheld box-type stereoscopic display devices is configured to sense an identification component to obtain an object identifier through a sensor, and store stereoscopic images, wherein each of the stereoscopic images corresponds to an image identifier. In a step 212, each of the handheld box-type stereoscopic display devices is connected to another of the handheld box-type stereoscopic display devices through a transmission component, and after connection, each of the handheld box-type stereoscopic display devices transmits the sensed object identifier, receives the object identifier sensed by the another of the handheld box-type stereoscopic display devices, and uses the received object identifier as a target identifier. In a step 213, each of the handheld box-type stereoscopic display devices compares the obtained object identifier and the received target identifier with the image identifiers, respectively, and when the obtained object identifier matches with one of the image identifiers, each of the handheld box-type stereoscopic display devices loads the corresponding stereoscopic image as a primary image, and when the received target identifier matches with one of the image identifiers, each of the handheld box-type stereoscopic display devices loads the corresponding stereoscopic image as an at least one secondary image. In a step 214, each of the handheld box-type stereoscopic display devices generates virtual stereoscopic images with a primary-secondary relationship for display based on the primary image and the secondary image. Through the above steps, the sensor of each handheld box-type stereoscopic display device can sense the identification component to obtain the object identifier; the handheld box-type stereoscopic display devices can be connected to each other through the transmission components thereof to exchange the sensed object identifiers; each handheld box-type stereoscopic display device uses the object identifier of another handheld box-type stereoscopic display device as the target identifier, loads the primary image and the secondary image based on the object identifier thereof and the received target identifier to generate virtual stereoscopic images with the primary-secondary relationship for display.

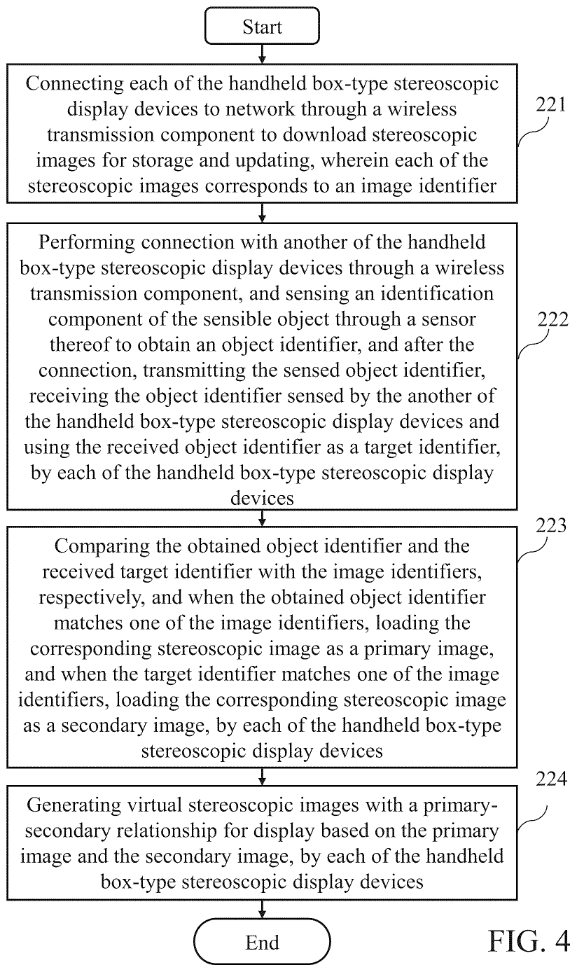

Please refer to FIG. 4. FIG. 4 is another flowchart of an interconnectable stereoscopic image interaction method, according to the present invention. The interconnectable stereoscopic image interaction method can be applied in an environment with sensible objects and handheld box-type stereoscopic display devices and include the following steps. In a step 221, each of the handheld box-type stereoscopic display devices is connected to network through a wireless transmission component to download stereoscopic images for storage and updating, wherein each of the stereoscopic images corresponds to an image identifier, in a step 222, each of the handheld box-type stereoscopic display devices performs connection with another of the handheld box-type stereoscopic display devices through a wireless transmission component thereof, and senses an identification component of the sensible object through a sensor thereof to obtain an object identifier, wherein after the connection, each of the handheld box-type stereoscopic display devices transmits the sensed object identifier, receives the object identifier sensed by the another of the handheld box-type stereoscopic display devices and uses the received object identifier as a target identifier. In a step 223, each of the handheld box-type stereoscopic display devices compares the obtained object identifier and the received target identifier with the image identifiers, respectively, when the obtained object identifier matches one of the image identifiers, each of the handheld box-type stereoscopic display devices loads the corresponding stereoscopic image as a primary image, and when the target identifier matches one of the image identifiers, each of the handheld box-type stereoscopic display devices loads the corresponding stereoscopic image as a secondary image. In a step 224, each of the handheld box-type stereoscopic display devices generates virtual stereoscopic images with a primary-secondary relationship for display based on the primary image and the secondary image. The steps 223 and 224 are the same as the steps 213 and 214, respectively, and the difference between the method flowcharts in FIG. 3 and FIG. 4 is that the first two steps are different, the method flowchart in FIG. 4 is to download, store, and update the stereoscopic images corresponding to the sensible objects 103 and 104 through the wireless transmission component, such as Wi-Fi, Zigbee, LoRa (Long Range), or similar components, through the network (such as the Internet or local network).

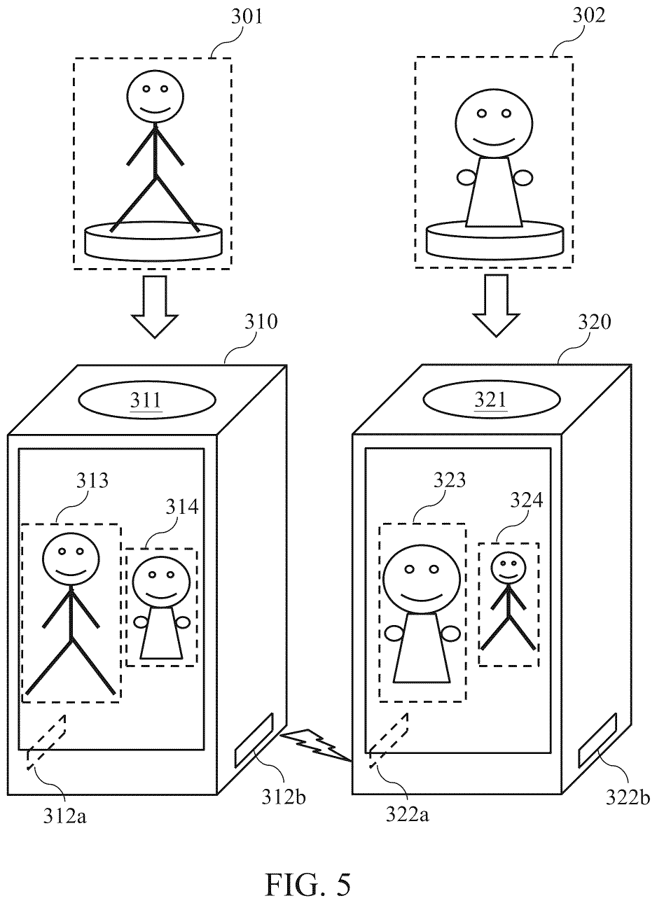

An embodiment of the present invention will be illustrated in the following paragraphs with reference to FIG. 5 to FIG. 7. Please refer to FIG. 5. FIG. 5 is a schematic view of an operation of connecting handheld box-type stereoscopic display device, according to an application of the present invention. In a condition that there is a handheld box-type stereoscopic display device 310 has transmission components 312a and 312b disposed on left and right sides thereof, and another handheld box-type stereoscopic display device 320 having transmission components 322a and 322b disposed on left and right sides thereof. At this time, to connect these two handheld box-type stereoscopic display devices 310 and 320, they can be directly attached, so that the transmission component 312b and the transmission component 322a are connected together through magnetic attraction to complete the connection. In this way, the two handheld box-type stereoscopic display devices 310 and 320 can transmit data through the transmission components 312b and 322a to interact with each other. In addition, besides the magnetic attraction method mentioned above, the transmission components can use Bluetooth, Wi-Fi, or similar technologies to connect the two handheld box-type stereoscopic display devices 310 and 320 through wireless communication and exchange data after connection.

A first user can place a cartoon figure 301 at a position of the sensor 311 of the handheld box-type stereoscopic display device 310, so that the handheld box-type stereoscopic display device 310 can sense an identification component of the cartoon figure 301 to obtain an object identifier, such as A0001; similarly, a second user can also place a cartoon figure 302 at a position of the sensor 321 of the handheld box-type stereoscopic display device 320, so that the handheld box-type stereoscopic display device 320 can sense an identification component of the cartoon figure 302 to obtain an object identifier, such as A0002. Next, both handheld box-type stereoscopic display devices 310 and 320 perform the same steps of transmitting the sensed object identifiers and receiving the object identifier transmitted by the other as the target identifiers through the respective transmission components 312b and 322a. Taking the object identifier A0001 and A0002 as examples, the handheld box-type stereoscopic display device 310 transmits the sensed object identifier A0001 to the handheld box-type stereoscopic display device 320, and the handheld box-type stereoscopic display device 320 uses the received object identifier A0001 as the target identifier; similarly, the handheld box-type stereoscopic display device 320 transmits the sensed object identifier A0002 to the handheld box-type stereoscopic display device 310, and the handheld box-type stereoscopic display device 310 uses the received object identifier A0002 as the target identifier. After the handheld box-type stereoscopic display device 310 (320) compares the object identifier and the target identifier with the image identifiers, respectively, when one of the image identifiers matches the object identifier, the handheld box-type stereoscopic display device 310 (320) loads the corresponding stereoscopic image as a primary image, when one of the image identifiers matches the target identifier, the handheld box-type stereoscopic display device 310 (320) loads the corresponding stereoscopic image as an secondary image. Next, as shown in FIG. 5, the handheld box-type stereoscopic display device 310 generates a primary virtual stereoscopic image 313 based on the loaded primary image and generates a secondary virtual stereoscopic image 314 based on the secondary image; in actual implementation, to establish a primary-secondary relationship, the primary virtual stereoscopic image 313 can be displayed in the foreground and the secondary virtual stereoscopic image 314 can be displayed in the background. Similarly, the handheld box-type stereoscopic display device 320 generates a primary virtual stereoscopic image 323 based on the loaded primary image and generates a secondary virtual stereoscopic image 324 based on the secondary image, thereby completing the connection and stereoscopic image interaction of the handheld box-type stereoscopic display devices 310 and 320. Therefore, the display content of the handheld box-type stereoscopic display device varies depending on the connected object and the differences in the sensed cartoon figure to present different stereoscopic images.

In actual implementation, each of the sensors 311 and 321 can simultaneously sense object identifiers, so that each of the handheld box-type stereoscopic display devices 310 and 320 can load corresponding stereoscopic images and integrate the stereoscopic images to generate the virtual stereoscopic image through an avatar system. The avatar system integrates the stereoscopic image through model stitching, multi-view reconstruction, 3D rendering and composition, 3D hierarchical composition, or similar technologies. For example, the model stitching technology can fuse 3D models or image data from different angles or sources into a completed virtual stereoscopic image. This process usually involves collecting data of the physical object from different perspectives, using feature matching algorithms, such as scale-invariant feature transform (SIFT), speeded up robust features (SURF), oriented FAST and rotated BRIEF (ORB), to spatially align these data from different perspectives. After alignment, the image data are fused and the overlapping areas are eliminated, thereby generating a seamless virtual stereoscopic image. The overall process usually employs techniques such as point cloud fusion, texture mapping, or mesh repair.

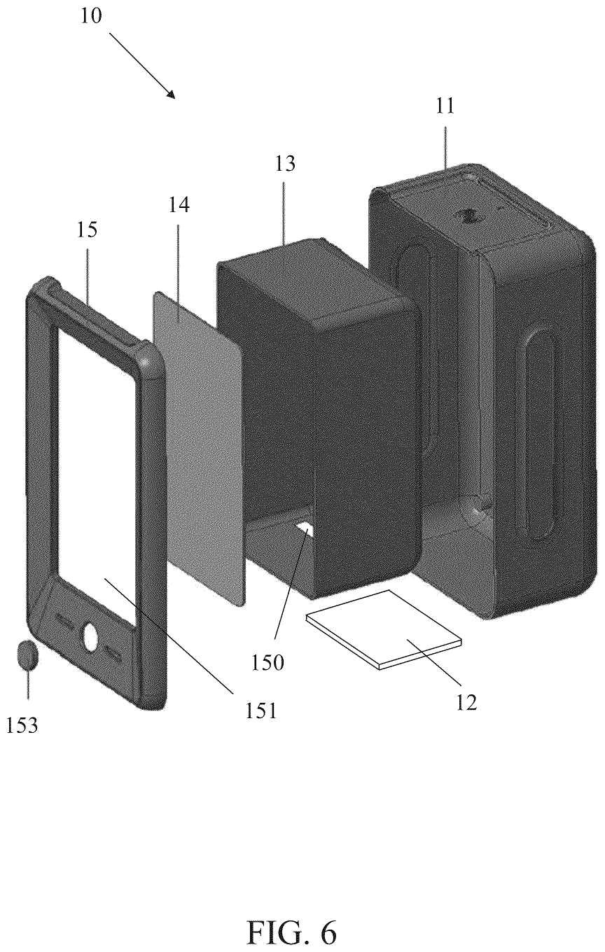

Please refer to FIG. 6. FIG. 6 is a perspective exploded view of a handheld box-type stereoscopic display device, according to the present invention. In actual implementation, the handheld box-type stereoscopic display device 10 includes an outer shell 11, a device motherboard 12, an embedded glass trough 13, a displayer 14, and a front cover 15. As shown in FIG. 6, the outer shell 11 is illustrated as a rectangular shape. In an embodiment, the outer shell 11 can also be in different geometric shapes, such as cylinders, prisms, or frustums. The outer shell 11 can be made of metal, polymer, or special materials. The aforementioned metal materials can include steel, aluminum alloy, or titanium alloy; the aforementioned polymer materials can include ABS, PC, or PC/ABS; the aforementioned special materials can include carbon fiber, or high glass fiber; however, these examples are merely for exemplary illustration, and the scope of application of the present invention is not limited thereto.

The device motherboard 12 is fixed at the bottom of an outer shell 11 through a screw fixing method, engagement fixing method or similar fixing method. For example, in the handheld box-type stereoscopic display device 110, the device motherboard 12 includes a sensor 111, a transmission component 112, a storage unit 113, a loading unit 114, and an image interaction unit 115. Additionally, the hardware components of handheld box-type stereoscopic display device 110 and the handheld box-type stereoscopic display device 120 are the same, so their detailed descriptions are not repeated herein. In addition, in the handheld box-type stereoscopic display device 130, the device motherboard 12 can be the smart device 133 including the network unit 134, the storage unit 135, the loading unit 136 and the image interaction unit 137, and is electrically connected to the sensor 131 through a connection wire. Similarly, the hardware components of the handheld box-type stereoscopic display device 140 and the handheld box-type stereoscopic display device 130 are the same, so their detailed descriptions are not repeated herein. The device motherboard 12 can be electrically connected to the battery embedded in the outer shell 11 to obtain power supply. The device motherboard 12 loads and executes the operating system, to make the handheld box-type stereoscopic display device 10 run the operating system.

The embedded glass trough 13 can be directly embedded and fixed in the outer shell 11, or the embedded glass trough 13 can cooperate with the front cover 15 to be embedded and fixed in the outer shell 11; however, these examples are merely for exemplary illustration, and the scope of application of the present invention is not limited thereto. The embedded glass trough 13 can be made of glass material in one piece and have the inner and outer edges and corners in rounded shape, and the outer surface of the embedded glass trough 13 is covered with a light-blocking film to make the outer surface of the embedded glass trough 13 opaque; however, these examples are merely for exemplary illustration, and the scope of application of the present invention is not limited thereto. A connection slot 131 is opened at the bottom of the embedded glass trough 13, to allow the displayer 14 embedded in the embedded glass trough 13 to be electrically connected to the device motherboard 12 through a flexible flat cable, the device motherboard 12 cooperates with the displayer 14 to display the generated virtual stereoscopic image within the handheld box-type stereoscopic display device 10.

It is particularly noted that, the embedded glass trough 13 prevents excess external light from entering the subsequent stereoscopic image display space, to avoid affecting the contrast of the virtual stereoscopic image presented in the stereoscopic image display space to enhance the sharpness of the virtual stereoscopic image, and make the light in the stereoscopic image display space controllable, effectively reducing environmental light interference, thereby improving the stability and clarity of the virtual stereoscopic image presented in the stereoscopic image display space.

In one embodiment, the inner surface of the embedded glass trough 13 can further include a partial reflection area and a partial transmission area, to make the inner surface of the embedded glass trough 13 form a “semi-lens” effect, which can enhance the floating sensation of the virtual stereoscopic image presented in the stereoscopic image display space. The inner surface of the embedded glass trough 13 can also be coated with an augmented reality coating layer or a polarized beam-splitting coating layer through optical coating technology (these examples are only for illustration purposes, and the scope of application of the present invention is not limited thereto), thereby reducing unnecessary light reflection in the stereoscopic image display space, ensuring the stability and clarity of the virtual stereoscopic image presented in the stereoscopic image display space, and enhancing the stereoscopic effect of the virtual stereoscopic image presented in the stereoscopic image display space.

In another embodiment, the embedded glass trough 13 can also be made into a waveguide structure, to make the light in the stereoscopic image display space evenly distribute to reduce parallax distortion, so that the virtual stereoscopic image can be viewed consistently from different angles. The handheld box-type stereoscopic display device 10 can further combine a multi-region optical system, dynamic parallax adjustment system, and/or dynamic viewing angle adjustment system, so that multiple viewers can simultaneously view the virtual stereoscopic image, and the virtual stereoscopic image can adapt to different viewing positions. The eye-tracking technology can be used to dynamically adjust the viewing angle of the virtual stereoscopic image output by the displayer 14 in real-time, thereby ensuring that the virtual stereoscopic image viewed from different positions is accurate. Similarly, these examples are merely for exemplary illustration, and the scope of application of the present invention is not limited thereto.

The displayer 14 can include a display panel and one of a parallax barrier layer, a cylindrical lens array layer and a light field display layer. The display panel of the displayer 14 is generally an LCD panel or OLED panel, and the display panel provides simultaneous display of images with multiple viewing angles. In an embodiment, the displayer 14 can have grating (mask) of the parallax barrier layer overlayed in front of the display panel, to allow the left and right eyes of a viewer to see different images. In an embodiment, the displayer 14 can have the cylindrical lens array layer overlayed in front of the display panel to achieve left and right eye parallax by blocking part of the pixels. In an embodiment, the displayer 14 can have the light field display layer overlayed in front of the display panel, and multi-layer display panels or holographic technology can be used to produce more natural multi-view images. The aforementioned examples are only for illustration purposes, and the scope of application of the present invention is not limited thereto.

The front cover 15 embedded with the transparent touch panel 151 covers the outer shell 11 by using screw fixing or snap fixing methods. The front cover 15 and the outer shell 11 are fixed to form a tight fit, and the transparent touch panel 151 covers the embedded glass trough 13 to form a tight stereoscopic image display space. The transparent touch panel 151 is electrically connected to the device motherboard 12 through a flexible flat cable, to enable touch selection and sliding operations. That is, the device motherboard 12 cooperates with the transparent touch panel 151 to achieve touch selection and sliding operations. The aforementioned transparent touch panel 151 can be made by using capacitive touch technology, optical touch technology, infrared touch technology, or ultrasonic touch technology. Among these technologies, the projected capacitive (P-Cap) touch technology in capacitive touch technology is the best implementation technology. These examples are merely for exemplary illustration, and the scope of application of the present invention is not limited thereto. In actual implementation, the virtual stereoscopic image displayed in the stereoscopic image display space by the displayer 14 can be viewed from different angles. When viewing the virtual stereoscopic image from the front angle and the left or right tilted angle, the touch-control elements for the virtual stereoscopic image, such as application icons, are projected to different positions on the transparent touch panel 151, and it causes correct touch operations on these elements from the front angle but incorrect touch operations from the left or right tilted angle. Therefore, a front camera combined with head tracking technology can be used to calculate the viewing angle of the virtual stereoscopic image in real-time, to dynamically adjust the mapping relationship of the touch points based on the change in viewing angle; the head tracking technology can compensate the touch offset caused by the change in viewing angle, thereby ensuring that the touch position accurately corresponds to the touch control elements of the virtual stereoscopic image under different viewing angles. The front camera, the infrared sensor, or the optical tracking system can be used to determine the viewer's eye position, and the parallax correction technology is then used to calculate the parallax change to dynamically correct the touch position mapping to the correct position of the touch control elements of the virtual stereoscopic image based on the viewer's viewing angle.

In actual implementation, the sensor is disposed on the top of the outer shell 11 and configured to sense the identification component outside the outer shell 11, such as a smart tag or a QR code. For example, in the handheld box-type stereoscopic display device 110, when the sensor 111 is a wireless sensor, the sensor 111 can sense a smart tag embedded in a physical object (such as a figure or a card) to obtain the object identifier; when the sensor 111 is an optical sensor, the optical sensor scans the QR code set on a surface of the physical object to obtain the object identifier. In practice, the sensor 111 and the device motherboard 12 can be electrically connected through a flexible flat cable. Additionally, since the hardware architecture of the handheld box-type stereoscopic display device 120 is the same as that of the handheld box-type stereoscopic display device 110, and the sensors of the handheld box-type stereoscopic display devices 130 and 140 are similar to that of the handheld box-type stereoscopic display device 110 (the difference is only in the electrical connection method), so detailed description is not repeated herein.

As mentioned above, in actual implementation, the outer shell 11 further provides an exposed slot for exposing the transmission component outside the outer shell 11; in this way, the handheld box-type stereoscopic display devices with the same hardware architecture can be electrically connected through the transmission components in a magnetic attraction manner. Taking two handheld box-type stereoscopic display devices 110 and 120 as an example, they can be electrically connected to each other through the transmission components 112 and 122 exposed outside the outer shells 11. It should be supplemented that the handheld box-type stereoscopic display device 10 can include a speaker device set in the outer shell 11 or the front cover 15. This speaker device can be electrically connected to the device motherboard 12 through a flexible flat cable and used to play background music and sound effects. Additionally, the handheld box-type stereoscopic display device 10 includes a button 153 set in the front cover 15. Similarly, this button 153 can be electrically connected to the device motherboard 12 through a flexible flat cable and used to select the virtual stereoscopic image displayed by the displayer 14 in cooperation with the touch operation of the transparent touch panel 151.

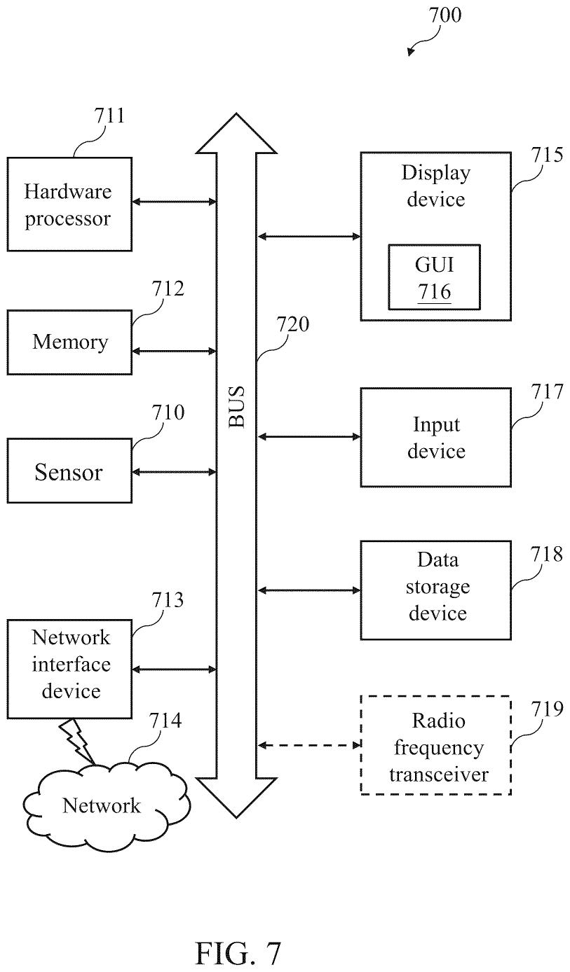

Please refer to FIG. 7. FIG. 7 is a schematic view of a hardware architecture of a smart device, according to the present invention. In the smart device 700, multiple computer-executable instructions (hereinafter referred to as instructions) are used to drive the machine to perform any one or more methods discussed in the present invention. In other embodiments, the machine can be connected (for example, via a network connection) to other machines in a local area network (LAN), internal network, external network, or the internet. The machine can operate as a server or client in a client-server network environment, or as a peer machine in a peer-to-peer network environment. The machine can also serve as a network device, server, router, switch or bridge, event generator, distributed node, centralized system, or any machine capable of executing a set of instructions (whether sequentially or in other forms) that specify actions to be taken by the machine. Moreover, although illustrated with a single machine, the term “machine” should be understood to include any collection of machines (such as tablets) that individually or collectively execute one or more sets of instructions to perform any one or more of the methods discussed in the present invention.

The smart device 700 (such as a tablet computer or a smart displayer) includes a hardware processor 711, a memory 712 (such as a read-only memory, a flash memory, a dynamic random access memory, a non-volatile resistive random access memory, an embedded flash memory, or a ferroelectric random access memory (FeRAM)), a network interface device 713, a display device 715, an input device 717, and a data storage device 718. The data storage device 718 may include fixed or removable computer-readable storage medium. These components communicate with each other through a bus 720. It is particularly noted that the bus 720 is electrically connected to the sensor 710, and the sensor 710 can be the sensor 111 or the sensor 121 shown in FIG. 1 or the sensor 131 shown in FIG. 2.

The hardware processor 711 can be a microprocessor, a central processing unit (CPU), or a similar device. More specifically, the hardware processor 711 can be a complex instruction set computer (CISC) microprocessor, a reduced instruction set computer (RISC) microprocessor, a very long instruction word (VLIW) microprocessor, a general-purpose instruction-based processor implementing another instruction set, or a general-purpose instruction-based processor implementing multiple instruction sets. Furthermore, the hardware processor 711 executes various software components stored in memory 712 to perform various functions for the smart device 700. In one embodiment, these software components include an operating system, a compiler component, and a communication module (or instruction set). The operating system includes various programs, instruction sets, software components, and/or drivers for controlling and managing general system tasks and facilitating communication among various hardware and software components. The compiler is a computer program (or a set of programs) that translates source code written in a programming language into another computer language (for example, a target language or object code). The communication module can communicate with other devices through the network interface device 713. The network interface device 713 connects to a network 714 (such as a local area network (LAN) or wide area network (wan)) for communication with other devices.

The memory 712 is configured to store code and/or data for use by the hardware processor 711. The memory 712 is implemented using random access memory (such as SRAM, DRAM, DDRAM), ROM, magnetic and/or optical storage devices, flash memory, or any combination thereof. The memory 712 includes transmission medium for carrying information-bearing signals representing instructions or data (which can be modulated signals with or without carrier waveforms).

The display device 715 (such as an LCD displayer, LED, or a cathode ray tube) is connected to the computer system through a display port and graphics chipset and provides a graphical user interface (GUI) 716 for user operation. In actual implementation, the display device 715 can be a touch screen or similar device with both input and display functions. Additionally, the input device 717 (such as a keyboard, a mouse, or a touchpad) can provide a user to input instructions and generate trigger signals.

The data storage device 718 can include a machine-readable storage medium (or more specifically, a computer-readable storage medium), which stores one or more instruction sets embodying at least one method or function discussed in the present invention. The disclosed data storage mechanism can be fully or at least partially implemented in the memory 712. The data storage device 718 (also known as a storage unit) and the memory 712 disclosed in the smart device 700 are configured to implement the data storage mechanism for performing the operations and steps discussed in the present invention.

It is particularly noted that the smart device 700 includes a radio frequency transceiver 719 to provide frequency conversion for converting the received radio frequency signal into a baseband signal and converting the baseband transmission signal into a radio frequency signal. In actual implementation, the radio frequency transceiver can be understood to include other signal processing functions, such as modulation/demodulation, encoding/decoding, interleaving/de-interleaving, spreading/despreading, inverse fast Fourier transforming (IFFT), fast Fourier transforming (FFT), cyclic prefix addition/removal, and other signal processing functions. When the sensor 122 in FIG. 2 is a wireless sensor, the sensor 122 can transmit the sensed data through a radio frequency transceiver 719 without direct electrical connection to the bus 720.

In one example, the smart device 700 can be a tablet computer, which can connect (such as internet connection) to a local internet (LAN), wide area internet (WAN), or any other machine on the internet. The smart device 700 can be a distributed system including many interconnected tablet computers. The tablet computer can act as a server or client in a client-server internet environment, or operate as a peer machine in a peer-to-peer (or distributed) internet environment.

According to above-mentioned contents, the difference between the present invention and the conventional technology is that, in the present invention, the sensor of each handheld box-type stereoscopic display device can sense the identification component to obtain the object identifier; the handheld box-type stereoscopic display devices can be connected to each other through the transmission components thereof to exchange the sensed object identifiers; each handheld box-type stereoscopic display device uses the object identifier of another handheld box-type stereoscopic display device as the target identifier, loads the primary image and the secondary image based on the object identifier thereof and the received target identifier to generate virtual stereoscopic images with the primary-secondary relationship for display.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An interconnectable stereoscopic image interaction system, comprising:
handheld box-type stereoscopic display devices, wherein each of the handheld box-type stereoscopic display devices comprises:
a sensor, configured to sense an identification component to obtain an object identifier;
a transmission component, configured to perform connection with another handheld box-type stereoscopic display devices, wherein after the connection, the transmission component transmits the sensed object identifier by the sensor and receive the at least one object identifier sensed by another of the handheld box-type stereoscopic display devices, and uses the received object identifier as at least one target identifier;
a storage unit, configured to store stereoscopic images, wherein each of the stereoscopic images corresponds to an image identifier;
a loading unit, connected to the transmission component, the storage unit, and the sensor, configured to compare the obtained object identifier and the received target identifier with the image identifiers, respectively, wherein when the obtained object identifier matches with one of the image identifiers, the loading unit loads the corresponding stereoscopic image as an primary image, when the received target identifier matches with one of the image identifiers, the loading unit loads the corresponding stereoscopic image as at least one secondary image; and
an image interaction unit, connected to the loading unit and configured to generate virtual stereoscopic images with a primary-secondary relationship for display based on the primary image and the secondary image.

2. The interconnectable stereoscopic image interaction system according to claim 1, wherein each of the object identifier and the target identifier comprises data representing a plurality of object categories, the object categories comprise main bodies, clothes, accessories, weapons, and armors, wherein when obtaining the object identifiers, the loading unit loads the stereoscopic images corresponding to the obtained object identifiers, the image interaction unit executes an avatar system to perform an image integration on the loaded stereoscopic images into the primary image, when the target identifiers are received, the secondary image is generated based on the obtained target identifiers in the same loading and integration manner, and the avatar system selects at least one of model stitching, multi-view reconstruction, 3D rendering and composition, and 3D hierarchical composition to perform the image integration.

3. The interconnectable stereoscopic image interaction system according to claim 2, wherein the stereoscopic image corresponds to a prompt, when the loading unit loads the stereoscopic image, the loading unit also loads the corresponding prompt, so the avatar system generates the virtual stereoscopic image based on the loaded prompt through a generative AI model of text-to-video, wherein the generative AI model is pre-trained with the stereoscopic images and the prompts corresponding thereto.

4. The interconnectable stereoscopic image interaction system according to claim 1, wherein the sensor comprises a wireless sensor and an optical sensor, the identification component comprises a smart tag and a QR code, the wireless sensor is configured to sense the smart tag embedded in the physical object to obtain the object identifier, and the optical sensor is configured to scan the QR code set on the surface of the physical object to obtain the object identifier.

5. An interconnectable stereoscopic image interaction system, comprising:
a plurality of sensible objects, wherein each of the plurality of sensible objects has an identification component to be sensed; and
a plurality of handheld box-type stereoscopic display devices, wherein each of the plurality of handheld box-type stereoscopic display devices comprises:
a sensor, configured to sense the identification component of one of the sensible objects to obtain an object identifier; and
a smart device, comprising:
a network unit, connected to network for transmitting data through a wireless transmission component, and configured to perform a connection with another of the handheld box-type stereoscopic display devices, wherein after the connection, the network unit transmits the sensed object identifier sensed by the sensor, receives the object identifier sensed by the another of the handheld box-type stereoscopic display devices, and uses the received object identifier as a target identifier;
a storage unit, connected to the network unit and configured to store stereoscopic images, wherein each of the stereoscopic images corresponds to an image identifier and is updated through the network unit;
a loading unit, connected to the network unit, the storage unit and the sensor, and configured to compare the obtained object identifier and the received target identifier with the image identifiers, respectively, wherein when one of the image identifiers matches with the object identifier, the loading unit loads the corresponding stereoscopic image as an primary image, and when one of the image identifiers matches with the target identifier, the loading unit loads the corresponding stereoscopic image as a secondary image; and
an image interaction unit, connected to the loading unit and configured to generate virtual stereoscopic images with a primary-secondary relationship for display based on the primary image and the secondary image.

6. An interconnectable stereoscopic image interaction method, executed in handheld box-type stereoscopic display devices, and comprising:
sensing an identification component to obtain an object identifier through a sensor, and storing stereoscopic images, by each of the handheld box-type stereoscopic display devices, wherein each of the stereoscopic images corresponds to an image identifier;
connecting to another of the handheld box-type stereoscopic display devices through a transmission component, and after connection, transmitting the sensed object identifier, receiving the object identifier sensed by the another of the handheld box-type stereoscopic display devices and using the received object identifier as a target identifier, by each of the handheld box-type stereoscopic display devices;
comparing the obtained object identifier and the received target identifier with the image identifiers, respectively, when the obtained object identifier matches with one of the image identifiers, loading the corresponding stereoscopic image as a primary image, and when the received target identifier matches with one of the image identifiers, loading the corresponding stereoscopic image as an at least one secondary image, by each of the handheld box-type stereoscopic display devices; and
generating virtual stereoscopic images with a primary-secondary relationship for display based on the primary image and the secondary image, by each of the handheld box-type stereoscopic display devices.

7. The interconnectable stereoscopic image interaction method according to claim 6, wherein each of the object identifier and the target identifier comprises data representing a plurality of object categories, the object categories comprise main bodies, clothes, accessories, weapons, and armors, wherein when obtaining the object identifiers, the loading unit loads the stereoscopic images corresponding to the obtained object identifiers, the image interaction unit executes an avatar system to perform an image integration on the loaded stereoscopic images into the primary image, when the target identifiers are received, the secondary image is generated based on the obtained target identifiers in the same loading and integration manner, and the avatar system selects at least one of model stitching, multi-view reconstruction, 3D rendering and composition, and 3D hierarchical composition to perform the image integration.

8. The interconnectable stereoscopic image interaction method according to claim 7, wherein the stereoscopic image corresponds to a prompt, when the loading unit loads the stereoscopic image, the loading unit also loads the corresponding prompt, so the avatar system generates the virtual stereoscopic image based on the loaded prompt through a generative AI model of text-to-video, wherein the generative AI model is pre-trained with the stereoscopic images and the prompts corresponding thereto.

9. The interconnectable stereoscopic image interaction method according to claim 6, wherein the sensor comprises a wireless sensor and an optical sensor, the identification component comprises a smart tag and a QR code, the wireless sensor is configured to sense the smart tag embedded in the physical object to obtain the object identifier, and the optical sensor is configured to scan the QR code set on the surface of the physical object to obtain the object identifier.

10. An interconnectable stereoscopic image interaction method, applied in an environment with sensible objects and handheld box-type stereoscopic display devices, comprising:
connecting each of the handheld box-type stereoscopic display devices to network through a wireless transmission component to download stereoscopic images for storage and updating, wherein each of the stereoscopic images corresponds to an image identifier;
performing connection with another of the handheld box-type stereoscopic display devices through a wireless transmission component, and sensing an identification component of the sensible object through a sensor thereof to obtain an object identifier, and after the connection, transmitting the sensed object identifier, receiving the object identifier sensed by the another of the handheld box-type stereoscopic display devices and using the received object identifier as a target identifier, by each of the handheld box-type stereoscopic display devices;
comparing the obtained object identifier and the received target identifier with the image identifiers, respectively, and when the obtained object identifier matches one of the image identifiers, loading the corresponding stereoscopic image as a primary image, and when the target identifier matches one of the image identifiers, loading the corresponding stereoscopic image as a secondary image, by each of the handheld box-type stereoscopic display devices; and
generating virtual stereoscopic images with a primary-secondary relationship for display based on the primary image and the secondary image, by each of the handheld box-type stereoscopic display devices.
